(19) United States
(12) Patent Application Publication
(10) Pub. No.: US 2010/0257004 A1
(43) Pub. Date: Oct. 7, 2010

(54) Method and system for conducting geologic basin analysis

(75) Inventors: Martin A. Perlmutter, Houston, TX (US); Craig W. Stichtenoth, Katy, TX (US); Anhkiet Tran, San Ramon, CA (US); Kenneth J. Nelson, Sugar Land, TX (US)

Correspondence Address: CHEVRON CORPORATION, P.O. BOX 6006, SAN RAMON, CA, 94583-0806, US

(73) Assignee: Chervon U.S.A. Inc.

(21) Appl. No.: 12/416,313

(22) Filed: Apr. 1, 2009

(51) Int. Cl. G06Q 10/00; G01V 9/00; G06F 19/00

(52) U.S. Cl. 705/7; 702/13

(57) ABSTRACT

A computer implemented method and system for conducting a geologic basin analysis in order to determine the accumulation of hydrocarbons in a subsurface region of interest. One embodiment of the present invention includes defining a basin analysis project within a subsurface region; applying at least one basin analysis workflow to the basin analysis project; and integrating the results of the basin analysis to generate basin analysis project results for the basin. The project results are used to optimize and manage the performance of technical tasks required for the basin analysis project in order to determine the accumulation of hydrocarbons in the subsurface region of interest.

### TECHNICAL FIELD

The present invention relates generally to hydrocarbon exploration and in particular to a computer implemented method and system for conducting a geologic basin analysis using at least one basin analysis workflow to determine the accumulation of hydrocarbons in a subsurface region of interest.

### BACKGROUND OF THE INVENTION

A geologic basin is comprised of hundreds of rock layers, strata or formations deposited over geologic time that must be understood to predict the location of hydrocarbon bearing reservoirs. To recover the petroleum from these reservoirs typically requires drilling through thousands of feet of overlying rock. The drilling of oil and gas wells is normally a very expensive endeavor. Consequently, before incurring this expense, those involved in the exploration for or exploitation of hydrocarbon reservoirs seek to obtain an understanding of the basin geology and, in particular, the basin sedimentology and stratigraphy so that an oil and gas well is drilled in the location that is likely to achieve the desired, result. In the case of oil and gas exploration, geologic and seismic data are used to predict the location of sedimentary rocks and structures that are likely to contain a hydrocarbon reservoir. Basin analysis is the foundation for exploration projects, identifying the elements that define the hydrocarbon reservoirs, hydrocarbon trends and limits of a petroleum system.

Basin analysis requires the integration of a plurality of disciplines, including but not limited to evaluating analog basins, interpreting and mapping seismic data, conducting a basin-wide structural analysis, analyzing the reservoir and carrier bed systems, evaluating the top and fault seal data, analyzing and mapping source data, and basin modeling, to predict the location of hydrocarbon bearing reservoirs. Presently, there are different methods and techniques available for conducting specific aspects of a basin analysis, but today's exploration project teams are facing technical challenges due to the lack of a consistent application of the multiple disciplines and the integration required to produce an accurate and complete basin analysis. As a consequence, any conclusions drawn with respect to sedimentology and hydrocarbon bearing reservoirs are subject to increasing uncertainty as the location of interest becomes increasingly remote from the locations where data have been obtained.

There is a need for an integrated computer environment which provides a consistent graphical user interface for both input and output that enables a user to: optimize the implementation of a basin analysis project; interface with multiple discipline basin analysis workflows; and integrate the results of the basin analysis, without having to use valuable time to learn multiple software applications. The present invention is intended to address this need.

### SUMMARY OF THE INVENTION

The present invention thus provides an integrated computer environment wherein a user is guided, through the multiple disciplined technical analyses used for basin analysis. The present invention was designed to optimize the implementation of basin analysis projects, promote consistency in conducting basin analysis, provide an efficient way of storing and accessing information regarding the entire petroleum system, prospect, basins and reservoirs, and to reduce the inherent risk in predicting the location of sedimentary rocks and structures that are likely to contain hydrocarbons.

One embodiment of the present invention includes a computer implemented method for conducting a geologic basin analysis in order to determine the accumulation of hydrocarbons in a subsurface region of interest. The method includes defining a basin analysis project relating to at least one basin within a subsurface region of interest using project scoping data and geological and geophysical data related to the subsurface region of interest in an integrated computer environment having at least a graphical user interface and multiple basin analysis workflows; each basin analysis workflow having user selectable tasks. The method further includes applying at least one basin analysis workflow to the basin analysis project and performing user selected tasks in the integrated computer environment, to carry out a basin analysis including determining the basin characteristics, geological trends and the likelihood of a hydrocarbon system; wherein the use of the basin analysis workflow is based upon the volume of data provided by the user through the performance of the selected tasks and the basin analysis project scoping data. The method additionally includes integrating the results of the basin analysis, project scoping data, and the geological and geophysical data in the integrated computer environment, to generate basin analysis project results for the basin, including an interactive technical activity planner; wherein the project results are used, to optimize and manage the performance of technical tasks required for the basin analysis project in order to determine the accumulation of hydrocarbons in the subsurface region of interest.

In an embodiment of the present invention the basin analysis project scoping data includes any one or more of defining project objectives, activities required to meet the project objectives, level of basin analysis required, experience level of the user, project start and end dates, exploration opportunity, subsurface data inventory and assessment, assessment of geological uncertainty, and prioritizing the project deliverables, costs, schedule, and budget. In another embodiment of the present invention the basin analysis project geological and geophysical data includes any one or more of the continent, country, latitude and longitude.

It is an object of the present invention to have embodiments utilizing a graphical output, wherein the graphical output includes the interactive technical activity planner and a graphical representation of the uncertainty related to the data used to perform the basin analysis. It is another object of the present invention to have embodiments utilizing a searchable project library that can be used to link to data, including other active and inactive basin analysis projects.

Another embodiment of the present invention includes basin analysis workflows, which include any one or more of data basin analysis workflow, regional basin analysis workflow, seismic basin analysis workflow, structural basin analysis workflow, reservoir basin analysis workflow, seal basin analysis workflow, source basin analysis workflow, and modeling basin analysis workflow.

It should also be appreciated, by one skilled, in the art that the present invention is intended to be used with a user computer system which includes, in general, an electronic configuration including at least one processor, at least one memory device for storing program code or other data, a video monitor or other display device (i.e., a liquid crystal display) and at least one input device. The processor is preferably a microprocessor or microcontroller-based platform which is capable of displaying images and processing complex mathematical algorithms. The memory device can include random access memory (RAM) for storing event or other data generated or used during a particular process associated, with the present invention. The memory device can also include read only memory (ROM) for storing the program code for the controls and processes of the present invention.

One embodiment of the present invention includes a user computer system configured, to perform a geologic basin analysis to determine the accumulation of hydrocarbons in a subsurface region of interest. The system includes a data storage device having computer readable data including the project scoping data and the geological and geophysical data related to the subsurface region of interest, and a plurality of basin analysis workflows, a graphical user interface, a display device; and a processor, configured and arranged to execute machine executable instructions stored, in a processor accessible memory for performing a method. The method includes defining a basin analysis project relating to at least one basin within a subsurface region of interest using project scoping data and geological and geophysical data related, to the subsurface region of interest in an integrated computer environment having at least a graphical user interface and multiple basin analysis workflows; each basin analysis workflow having user selectable tasks.

The method further includes applying at least one basin analysis workflow to the basin analysis project and performing user selected tasks in the integrated computer environment, to carry out a basin analysis including determining the basin characteristics, geological trends and the likelihood of a hydrocarbon system; wherein the use of the basin analysis workflow is based upon the volume of data provided by the user through the performance of the selected tasks and the basin analysis project scoping data. Additionally, the method includes integrating the results of the basin analysis, project scoping data, and the geological and geophysical data in the integrated computer environment, to generate basin analysis project results for the basin, including an interactive technical activity planner; wherein the project results are used to optimize and manage the performance of technical tasks required for the basin analysis project in order to determine the accumulation of hydrocarbons in the subsurface region of interest.

It should be appreciated by one skilled in the art that the computer environment includes a user computer system, a network and a server; wherein the user computer system implements a web browser, and the user computer system displays web pages provided to the web browser by the server.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of the invention. As used in the specification and in the claims, the singular form of “a”, “an”, and “the” include plural references unless the context clearly dictates otherwise.

### BRIEF DESCRIPTION OF THE DRAWINGS

These and other objects, features and advantages of the present invention will become better understood with regard to the following description, pending claims and accompanying drawings where:

FIG. 1 illustrates a flow chart of an embodiment of the present invention;

FIG. 2 schematically illustrates an example of a system for performing the present invention;

FIG. 3 illustrates an example web page in an integrated computer environment for embodiments of the present invention;

FIG. 4 illustrates a flow chart for one embodiment of the present invention;

FIG. 5 illustrates an example web page in an integrated computer environment for embodiments of the present invention;

FIG. 6 illustrates an example web page in an integrated computer environment for embodiments of the present invention;

FIG. 7 illustrates an example web page in an integrated computer environment for embodiments of the present invention;

FIGS. 8A and 8B illustrate flow charts of certain embodiments of the present invention;

FIGS. 9A and 9B illustrate flow charts of certain embodiments of the present invention;

FIGS. 10A and 10B illustrate flow charts of certain embodiments of the present invention;

FIGS. 11A and 11B illustrate flow charts of certain embodiments of the present invention;

FIG. 12 illustrates an example web page in an integrated computer environment for embodiments of the present invention;

FIG. 13 illustrates an example web page in an integrated computer environment for embodiments of the present invention;

FIGS. 14A and 14B illustrate example web pages in an integrated computer environment for embodiments of the present invention;

FIGS. 15A, 15B, 15C and 15D illustrate an example Technical Activity Planner in accordance with embodiments of the present invention;

FIGS. 16A and 16B illustrate example web pages in an integrated computer environment for embodiments of the present invention; and

FIG. 17 illustrates an example web page in an integrated computer environment for embodiments of the present invention;

### DETAILED DESCRIPTION OF THE INVENTION

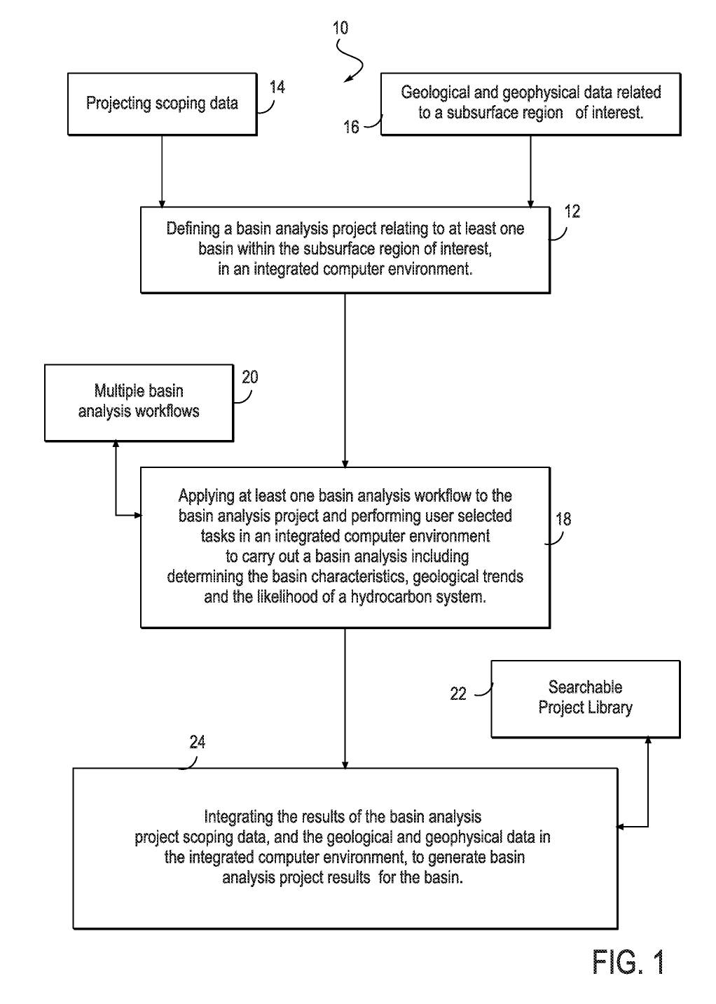

FIG. 1 shows a flowchart 10 of one embodiment of the present invention. The embodiment includes a computer implemented method for performing a basin analysis in order to determine the accumulation of hydrocarbons in a subsurface region. The operations shown in method 10 and presented below are intended to be illustrative. In some embodiments, method 10 may be accomplished with one or more additional operations not described, and/or without one or more of the operations discussed. Additionally, the order in which the operations of method 10 are illustrated in FIG. 1 and described below is not intended to be limiting.

The method 10 starts at an operation 12, where a basin analysis project relating to at least one basin within a subsurface region of interest is defined in an integrated computer environment using project scoping data 14 and geological and geophysical data 16 related to the subsurface region of interest. The method includes at operation 18, applying at least one basin analysis workflow 20 to the basin analysis project and performing user selected tasks in the integrated computer environment, to carry out a basin analysis including determining the basin characteristics, geological trends and the likelihood of a hydrocarbon system. The method also includes at operation 24, integrating the results of the basin analysis, project scoping data, and the geological and geophysical data in the integrated computer environment, to generate basin analysis project results for the basin which are used to optimize and manage the performance of technical tasks required, for the basin analysis project in order to determine the accumulation of hydrocarbons in the subsurface region of interest. The method can include an operation 22 wherein each basin analysis project has access to, and is saved in, a searchable project library that can be used to link to data, including other active and inactive basin analysis projects.

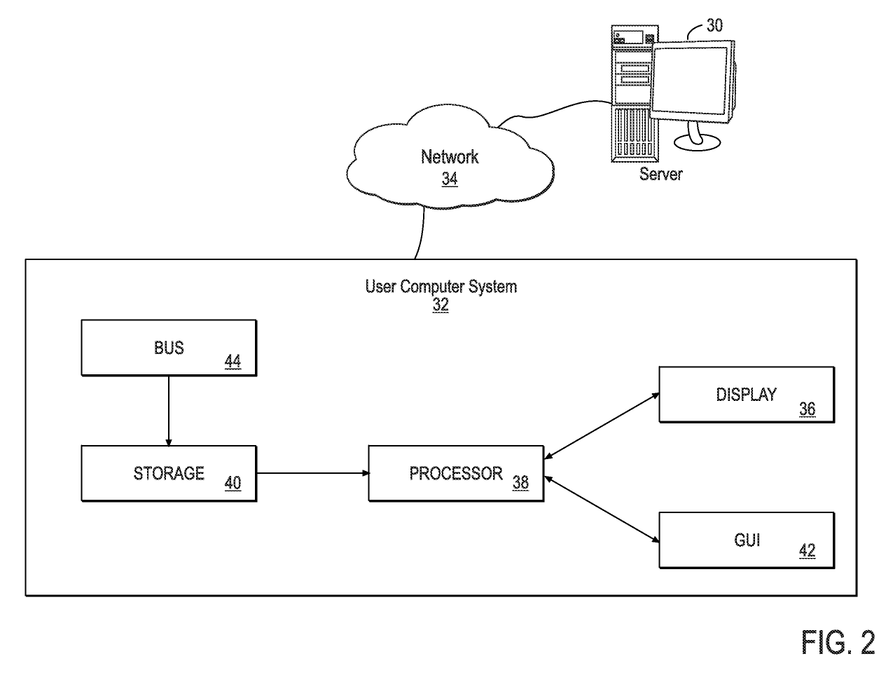

In some embodiments, the method 10 may be implemented in an integrated computer environment. FIG. 2 illustrates a simplified and exemplary integrated computer environment according to one embodiment of the present invention. The embodiment illustrated in FIG. 2 includes a server 30 and a user computer system 32, which may be connected to a network 34 such as the internet. However, it is noted that the present invention may be utilized with respect to any number of servers 30 and user computer systems 32. Embodiments of the present invention may also be used with any of various types of networks, including, but not limited to, local area networks (LANs), wide area networks (WANs), intranets, and networks of networks, such as the Internet, which connects computers and networks of computers together, thereby providing the connectivity for enabling communication and information exchange. Thus, the network 34 may be any of various types of networks including the Internet, including wired and wireless networks, or combinations thereof.

User computer system 32 may also be connected to the network 34. The user computer system 32 may be of various kinds of systems such as a computer system, a workstation, a terminal, a network appliance, an Internet appliance, a Personal Digital Assistant (FDA), WEB TV, or telephone. In some embodiments, the user computer system 32 may include one or more processing devices 38 (e.g., a programmable general purpose computer, a digital processor, an analog processor, a digital circuit designed to process information, an analog circuit designed, to process information, a state machine, and/or other mechanisms for electronically processing information). The user computer system 32 may also include a data storage device 40 or memory medium on which computer programs according to the present invention are stored and may be made available to a processor 38. The term “memory medium” is intended to include various types of memory or storage, including an installation medium, e.g., a CD-ROM, or floppy disks, a computer system memory, e.g., a random access memory (RAM), such as DRAM, SRAM, EDO RAM, or Rambus RAM, or a non-volatile memory such as a magnetic media, e.g., a hard drive, or optical storage. The memory medium may comprise other types of memory as well, or combinations thereof.

In addition, the memory medium may be located in a first computer in which the programs are executed, or may be located in a second, different computer which connects to the first computer over a network 34. In the latter instance, the second computer provides the program instructions to the first computer for execution. The memory medium may store software and other information for enabling an integrated computer environment according to the methods or flowcharts described below. The software may be implemented in any of various ways, including procedure-based techniques, component-based techniques, and/or object-oriented techniques, among others. A processor 38, executing code and data from a memory medium comprises a means for implementing an integrated, computer environment according to the methods, flowcharts or screen shots described below.

The processor 38 may include interface components such as a display device 36 and a graphical user interface 42. Display devices may include, but are not limited, to, CRTs, flat screens, LCDs, monitors, televisions, or other devices capable to textually and/or graphically display information provided by a computer system such as user computer system 32. The graphical user interface (GUI) 42 may be used both to display data and processed data products and to allow the user to select among options for implementing aspects of the method. Data may be transferred to the user computer system 32 via a bus 44 either directly from a data acquisition device, or from an intermediate storage or processing facility (not shown).

The user computer system 32 may execute software which provides the user with a user interface to the integrated computer environment. This user interface software may also allow the user of the user computer system 32 to browse and/or search the network 34, and also may allow the user to conduct actions over the network 34. In one embodiment, the user interface software may implement a front-end application to the integrated computer environment. In one embodiment, the user interface software may implement a web browser. In one embodiment, when the user of the user computer system 32 desires to access the integrated computer environment over the network 34, the user interface software may be used to access the respective server, such as server 30. The user interface software may then be used to access one or more displays provided, by the server 30 directly, or may access the displays through a link from a third party (e.g. a web site on the server 30 or on another server). The term “display” may include the notion of a page, screen, window, web page or other information presentation object that may be presented to an end user on a display device 36 or mechanism coupled to a processor 38.

The server 30 may include various standard components such as one or more processors or central processing units, one or more memory media, and other standard components, e.g., a display device, input devices, a power supply, etc. The server 30 may also be implemented, as two or more different computer systems. The server 30 may include a memory medium on which computer programs according to the present invention are stored. Also, the server 30 may take various forms, including a computer system, mainframe computer system, workstation, or other device. In general, the term “computer system” or “server” can be broadly defined to encompass any device having a processor that executes instructions from a memory medium. A server 30, executing code and data from a memory medium comprises a means for implementing an integrated computer environment according to the methods, flowcharts or screen shots described below.

In one embodiment, the integrated computer environment may be implemented on the Internet as a web site or sites provided by one or more web servers. The web site or sites may be accessed, by an end user through the user interface software (typically a web browser such as Microsoft Internet Explorer and Netscape Communicator). The web server may then “serve” one or more web pages of the web site to the user computer system 32. The web pages may be displayed on the user computer system by the user interface software (e.g. web browser) to provide a user interface to the integrated computer environment. The web site or sites may thus provide a mechanism by which end users may navigate the integrated computer environment to locate and display content from the basin analysis workflows to the end user on the user computer system 32.

In one embodiment, the integrated computer environment may be accessed on the network 34 through a network connection, dialup connection, wireless connection or other connection method. In one embodiment, the integrated, computer environment may be stored on a hard disk, CD ROM or other media accessible from the user computer system 32. For example, the integrated computer environment may be stored, on a CD. The CD may be inserted into a CD ROM drive on the user computer system 32. The user may then execute user interface software (stored on the user computer system or alternatively on the CD) to access the integrated computer environment. Various embodiments may further include receiving, sending or storing instructions and/or data implemented in accordance with the foregoing description.

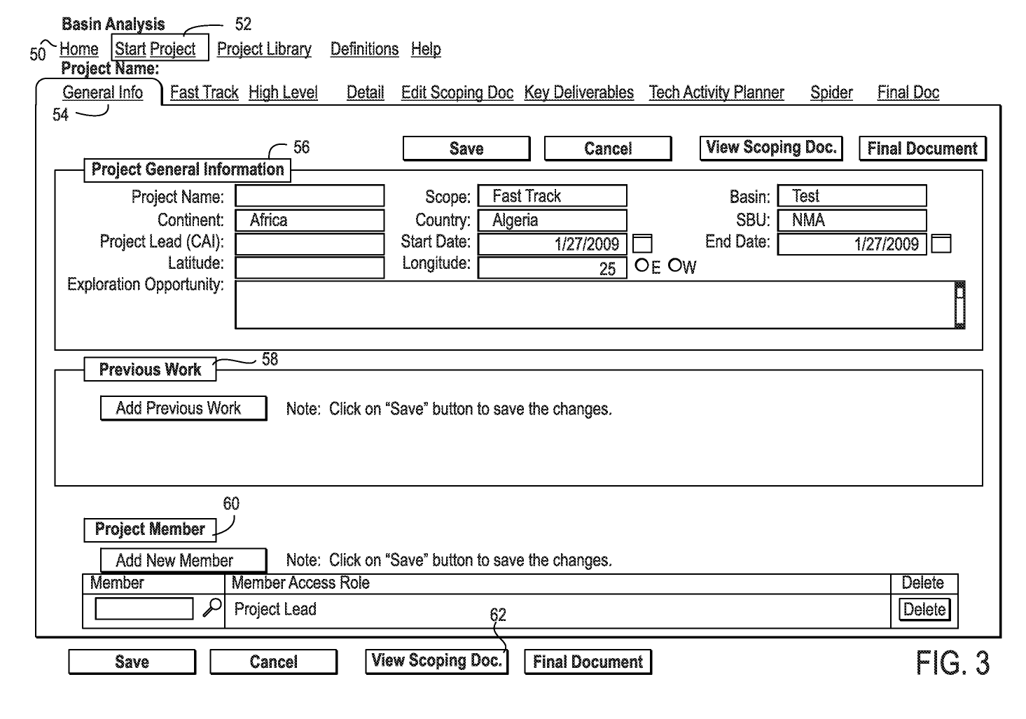

Referring to FIG. 3, illustrates an exemplary hierarchy of pages or displays for accessing content in an integrated computer environment for performing a basin analysis relating to at least one basin within a subsurface region of interest. In one embodiment, the displays may be web pages. A home page 50 may include one or more links to access pages in the next level of web pages, such as the Start Project page 52 shown in FIG. 3. For the purpose of this document, a link may be defined as a selectable connection from one word, picture, or information item to another. On a computer display, a link may be represented by an item such as an icon, picture, text string (e.g. word, phrase, or section of text), Uniform Resource Identifier (URI), Uniform Resource Locator (URL), network address such as an IP address, or other item. In a multimedia environment such as the World Wide Web, such items may include sound and motion video sequences. The most common form of link is the highlighted word or picture that can be selected by the user (with a mouse or in some other fashion), resulting in the immediate delivery and view of another object such as a file, web page, or another location on the page that includes the highlighted item. In some embodiments, the pages include one or more user selectable tasks. To initiate a basin analysis project within the integrated computer environment the Start Project page 52 may be accessed and a basin analysis project may be defined by a user. General information 54 pertaining to at least one basin in a subsurface region of interest may be entered, including, but not limited to: project general information 56 (project name continent, project lead, exploration opportunity, country, basin, business unit, latitude, longitude, start date, end date, and scope); previous work 58; and project members 60.

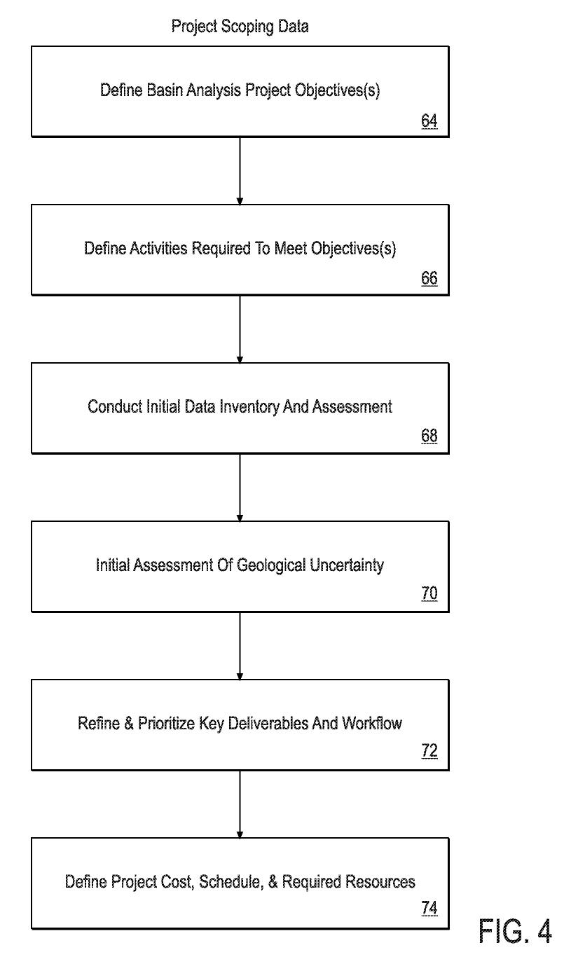

The basin analysis project may be further defined using project scoping data and geological and geophysical data related to the subsurface region of interest. The project scoping data and geological and geophysical data may be entered using the View Scoping Doc. link 62, to access the Project Scoping Data page illustrated in FIG. 4. Project scoping data and geological and geophysical data pertaining to at least one basin in a subsurface region of interest may be entered by a user, including, but not limited to: define basin analysis project objective(s) (customers of the basin analysis project, stakeholders of the basin analysis project, customer objectives and expectations, define test project decisions to be made based on the basin analysis project work, define what is “in” scope for the project frame, define what is “out” of scope for the project frame, define things that are not clearly “in” or “out” of scope for the project frame, and identify potential obstacles to the project) 64; define activities required to meet objective(s) (key project decisions, meetings and timing, key project decision makers, key project deliverables And timing of those deliverables, identify test data requirements to evaluate key deliverables, key technical milestones, list the activities required to produce the deliverables which support the project decisions, determine what type of basin modeling should be performed (1, 2 or 3D), and plan to document the project work and results) 66; conduct initial data inventory and assessment (define whether the data is in measured, modeled, extrapolated, inferred, or analog, identify data gaps and establish a forward plan to mitigate those gaps, and re-evaluate the project objective(s) based on the data inventory and assessment) 68; initial assessment of geological uncertainty (define initial geologic uncertainties from the assessment of the data) 70; refine and prioritize key deliverables and workflow (review key deliverables, data availability, data type and work schedule check for compatibility between deliverables and data, and review and finalize workflow: ensure that the timeframe for deliverables and key decision points are compatible) 72; and define project cost, schedule, and required resources (review project deliverables, project milestones, and decision points with customers, review and update data requirements needed by project milestones, determine appropriate resources/staff planning for project activities, estimated cost, feasibility of completing the project on time and within budget, review and communicate to the customers and stakeholders to ensure alignment, communicate the consequences of not following the proposed project plan to the customer, and possible alternative paths to completing the objectives and agreed upon with the customer) 74.

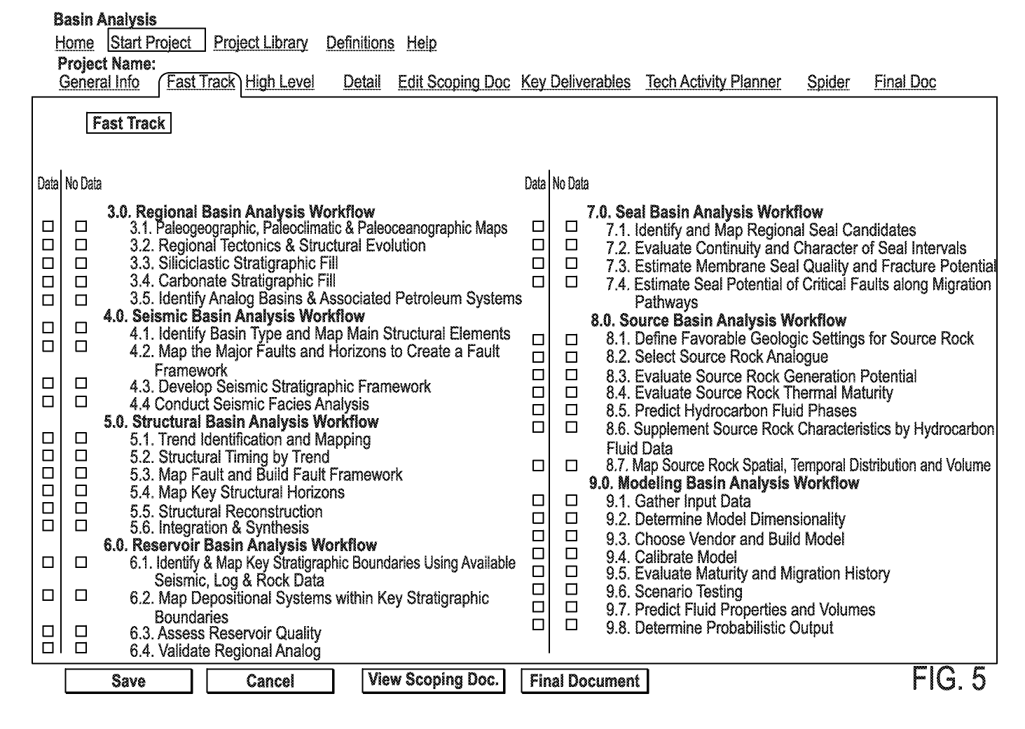

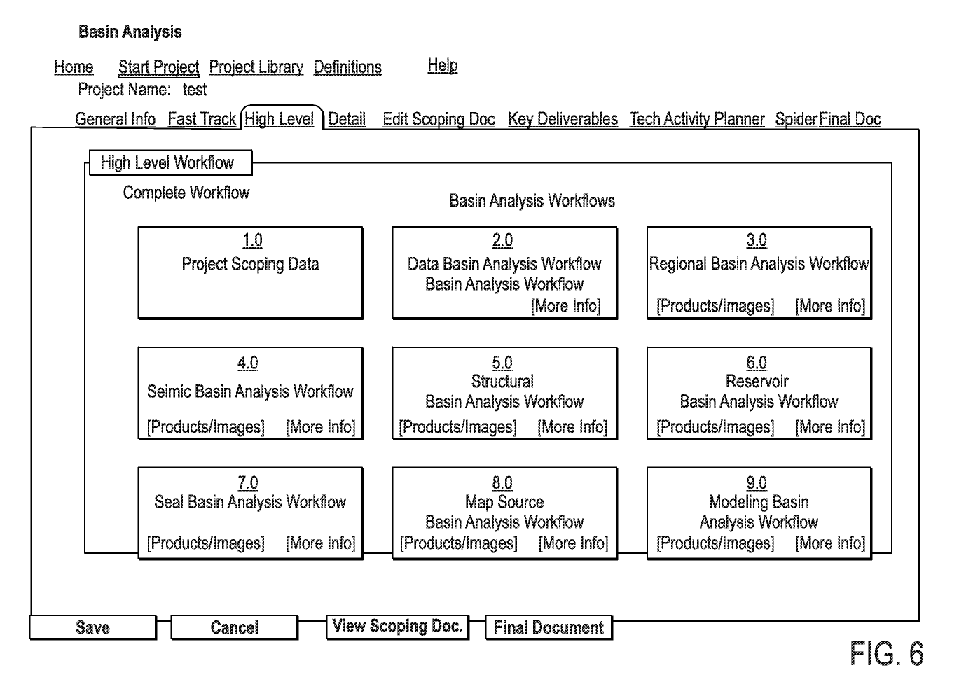

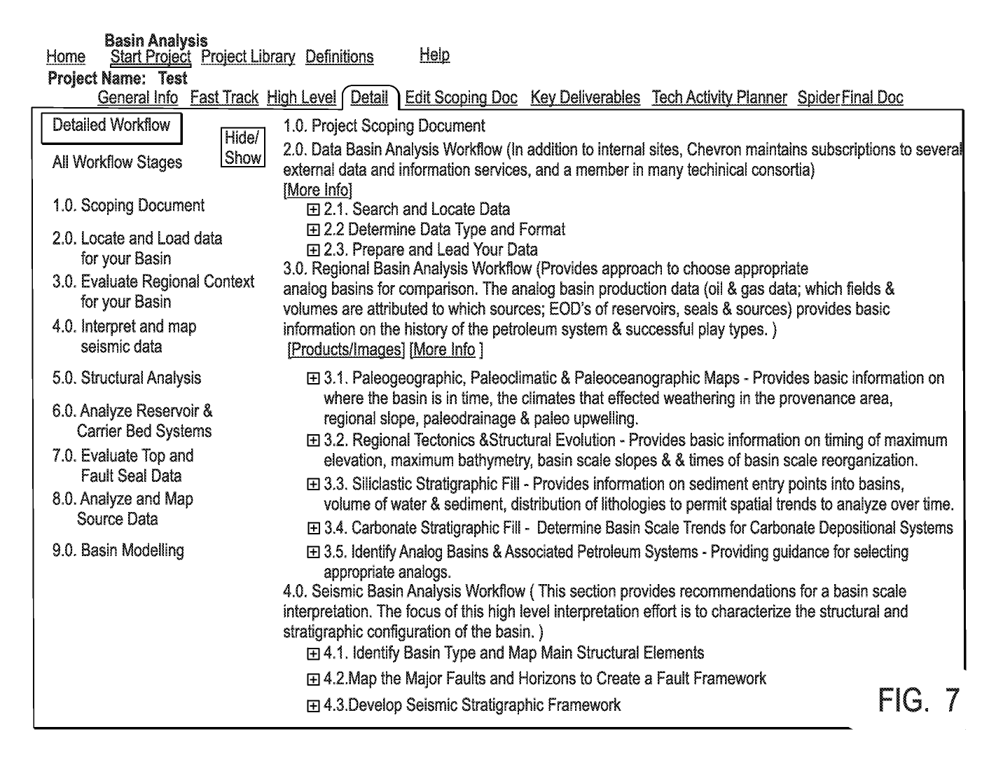

Based upon the volume of data provided by the user through the performance of the user selected links and tasks, and the basin analysis project scoping data, at least one basin analysis workflow may be applied to the basin analysis project in the integrated computer environment to carry out a basin analysis including determining the basin characteristics, geological trends and the likelihood of a hydrocarbon system. In some embodiments, there are specific pathways depending on the goals, experience and perspective of the user, objectives of the project and volume of information. There is a Fast Track pathway, as shown in FIG. 5, for basin analysis projects that have limited data or are time constrained, a High Level pathway, as shown in FIG. 6, for project managers and experienced geologists, and a Detailed pathway, a portion of which is shown in FIG. 7, for technical specialists. The basin analysis workflows may be applied to the basin analysis project using any of the pathways. When accessed and displayed through a pathway, the basin analysis workflows include one or more user selectable tasks to be performed. The basin analysis workflows include, but are not limited to: a data basin analysis workflow, a regional basin analysis workflow, a seismic basin analysis workflow, a structural basin analysis workflow, a reservoir basin analysis workflow, a seal basin analysis workflow, a source basin analysis workflow, and a modeling basin analysis workflow.

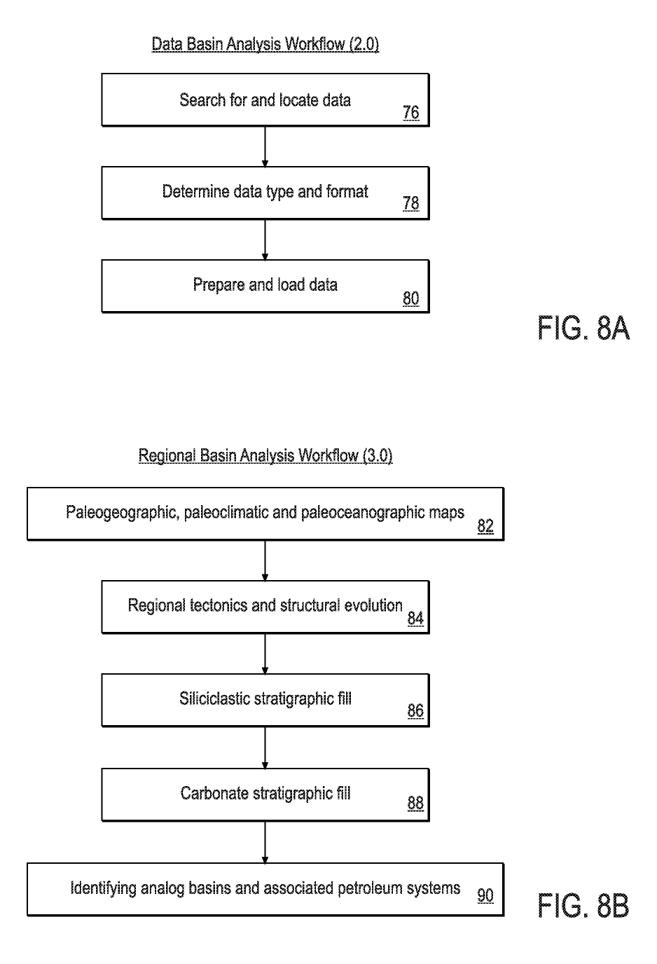

FIG. 8A is a flow chart illustrating one method in an embodiment of the present invention of using the user selectable tasks for the data basin analysis workflow. The data basin analysis workflow pages may include tasks, including but not limited to: search for and locate data 76, determine data type and format 78, and prepare and load data 80.

The tasks for search for and locate data 76 may, when displayed, include: hard copy geologic, geophysical and well data and reports, technical records for hard copy data and reports, digital seismic and well log data, check active and archived, projects for georeferenced digital and scanned data, landsat imagery, digital elevation maps, potential fields, basin reports, prospect review reports, and determine data available for purchase. The tasks to determine data type and format 78, may, when displayed, include: ARCGIS format for scan and georeference maps and data from reports and references, topography and digital elevation maps, OpenWorks format for digital seismic and wells, vectorized (digitized) contours from hard copy maps, SharePoint, PowerPoint files, reports, spreadsheet data, and references (pdfs). The tasks to prepare and load data 80, may, when displayed, include: organize support team, set up organized project structures in ARCGIS, OpenWorks and shared drive for data storage and retrieval by team, determine correct coordinate reference system early in the project, quality control all data, and load the data. ARCGIS® is a registered U.S. trademark owned by Environmental Systems Research Institute, and OpenWorks® is a registered. U.S. trademark owned by Landmark Graphics Corporation.

FIG. 8B is a flow chart illustrating one method in an embodiment of the present invention of using the user selectable tasks for the regional basin analysis workflow for evaluating the regional context of a basin. The regional basin analysis workflow pages may include, but are not limited to: paleogeographic, paleoclimatic and paleoceanographic maps 82, regional tectonics and structural evolution 84, siliciclastic stratigraphic fill 86, carbonate stratigraphic fill 88, and identifying analog basins and associated petroleum systems 90.

The regional basin analysis workflow provides an approach to choose appropriate analog basins for comparison. The analog basin production data provides basic information on the history of the petroleum system and successful play types. Tasks for paleogeographic, paleoclimatic and paleoceanographic maps 82, may, when displayed provide basic information on where the basin is in time, the climates that effected weathering in the provenance areas, regional slope, paleodrainage and paleo upwelling and include: map the paleolatitude of the basin through time, map the distribution of regional topography, map the distribution of paleoclimate, and map the distribution of paleo-upwelling. The tasks for regional tectonics and structural evolution 84, may, when displayed provide basic information on timing of maximum elevation, maximum bathymetry, basin scale slopes and times of basin scale reorganization, and include: define basin tectonic style and plate tectonic setting, determine the timing, location and maximum elevation of provenance areas, determine timing of formation of accommodation space, determine timing of major changes affecting the basin. The tasks for siliciclastic stratigraphic fill 86, may, when displayed, provide information on sediment entry points into basins, volume of water and sediment, distribution of lithologies to permit spatial trends to analyzed, over time, and may include: develop chronostratigraphic framework, map paleodrainage systems and river entry locations, river runoff, clastic sediment supply from rivers, and evaluate likely distribution of siliciclastic depositional environments. The task for carbonate stratigraphic fill 88 may, when displayed determine basin scale trends for carbonate depositional systems, and include: use rock, well and seismic data to identify carbonate buildups and related seismic reflection architectures, determine geologic age to define carbonate reservoir building organisms and their environmental conditions of occurrence using paleogeographic maps, paleoclimate maps, paleoceanographic maps, and paleodrainage maps. The tasks to identify analog basins and associated petroleum systems 90 may, when displayed, provide guidance for selecting appropriate analogs, including: identify producing basins with similar size basin type, structural styles, and trap class, identify producing basins with similar paleoclimatic controls on sedimentation, identify producing basins of similar age depositional environments, estimate potential hydrocarbon volume based on analog basins basic data.

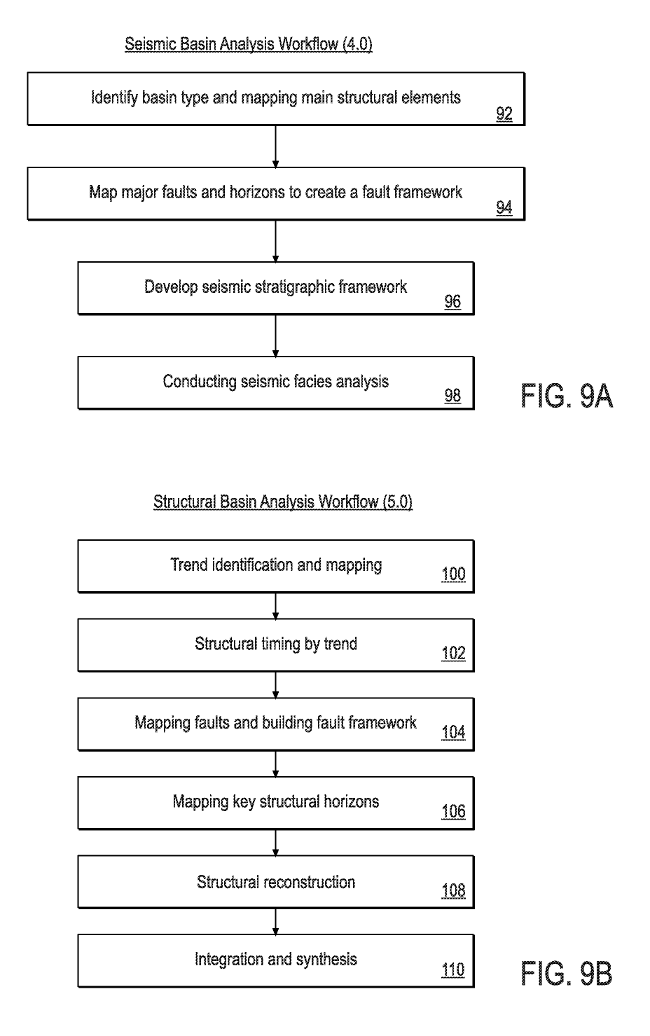

FIG. 9A is a flow chart illustrating one method in an embodiment of the present invention of using the user selectable tasks for the seismic basin analysis workflow for interpreting and mapping seismic data for the basin interpretation. The focus of this high level interpretation effort is to characterize the structural and stratigraphic configuration of the basin. The seismic basin analysis workflow pages may include, but are not limited to: identify basin type and map main structural elements 92, map the major faults and horizons to create a fault framework 94, develop seismic stratigraphic framework 96 and conduct seismic fades analysis 98.

The tasks to identify basin type and map main structural elements 92, may, when displayed include: identify basin type, identify main structural regimes, and use analogs to review data. The tasks to map the major faults and horizons to create a fault framework 94, may when displayed include: map main structural features and trends, map fault framework, and use analogs and consult structural team. The tasks to develop seismic stratigraphic framework 96, may when displayed include: determine stratigraphic framework, distinguish carbonate, clastic and evaporite intervals, and identify candidates for reservoir, source and seal. The tasks to conduct seismic fades analysis 98, may when displayed include: determine the phase of the seismic data and correlate seismic data with well data, identify main structural regimes, and use analogs to determine likely locations of favorable source rocks, potential reservoirs and seals.

FIG. 9B is a flow chart illustrating a method in one embodiment of the present invention of using the user selectable tasks for the structural basin analysis workflow for analyzing the structure of the basin. Basin-wide structural analysis involves defining trends by structural style and timing, mapping faults and structurally significant surfaces, performing restorations and integrating results. The structural basin analysis workflow pages may include, but are not limited, to: trend identification and mapping 100, structural timing by trend 102, map faults and building fault framework 104, map key structural horizons 106, structural reconstruction 108, and integration and synthesis 110.

The tasks for trend identification and mapping 100, may, when displayed provide the regional context for ail subsequent reservoir, seal and charge analyses, and include the identification of trends based on structural style, location and orientation using; Landsat, 2D seismic, geologic maps, aerial photos, tectonic maps and publications. Trends can be classified as extensional, contractional, strike-slip, diapiric, and basement trends. Tasks may further include: identify fold and fault trends, examine structural relationships between trends, and evaluate tectonic styles. The tasks for Structural Timing by Trend 102, may, when displayed, identify key episodes of structural growth and include: define growth intervals for tectonic trends, timing of activity of tectonic trends, and modern day tectonics of the basin. The tasks for map faults and build fault framework 104, may, when displayed include: analyze significant faults, analyze cross-cutting faults, framework validation, and throw/separation maps. The tasks for map key structural horizons 106, may, when displayed identify unconformities and other structural surfaces that may not have great sedimentological or biostratigraphic significance but are critical for understanding the structural evolution of a basin, and include: map key structural horizons, evaluate tectonic unconformities, and map basal detachment surface(s). The tasks for structural reconstruction 108, may when displayed, perform structural reconstruction scaled as appropriate to the data and geologic problem, and include: determine appropriate dimension (2 or 3D) of reconstruction, types of 2D reconstructions, and types of 3D reconstructions. The tasks for integration and synthesis 110, may, when displayed integrate structural analysis with regional geology and basin modeling, and include: communicate output, and tie back to regional evaluation to ensure consistency.

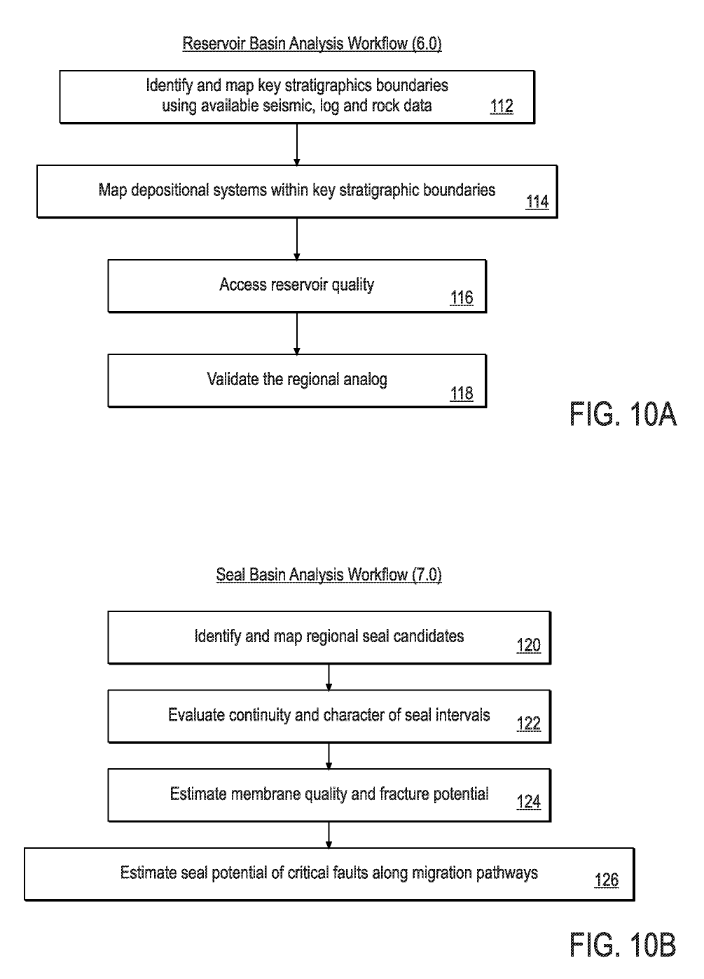

FIG. 10A is a flow chart illustrating a method in one embodiment of the present invention of using the user selectable tasks for the reservoir basin analysis workflow for analyzing the basin's reservoir and carrier bed systems. The reservoir basin analysis workflow pages may include, but are not limited, to: identify and map key stratigraphic boundaries using available seismic, logging and rock data 112, map depositional systems within key stratigraphic boundaries 114, assess reservoir quality 116, and validate the regional analog 118.

The tasks for identify and map key stratigraphic boundaries using available seismic, log and rock data 112, divides stratigraphy into the primary depositional packages that can be related to the evolution of the basin, and may when displayed include: identify and map key stratigraphic surfaces, develop regional sequence stratigraphic framework key steps, and create and analyze isopach maps of major stratigraphic intervals. The tasks for map depositional systems within key stratigraphic boundaries 114, subdivide stratigraphy into depositional systems that can be evaluated for iithology, reservoir, seal and source prone rocks and carrier beds, and may when displayed include: establish the physiographic framework of the basin, subdivide major intervals into sequences and systems tracts, map depositional systems for key systems tracts for identification of reservoir prone beds, and identify and map carrier bed fades. The tasks for assess reservoir quality 116, provide the distribution of porosity and permeability in time and space in key reservoir and carrier bed intervals, and may when displayed include: workflow for when rock data is available in the basin of interest, workflow when rock data is not available but log data is available in the basin of interest, and workflow when no rock or log data are available in the basin of interest. The task for validate the regional analog 118, is designed to ensure compatibility between the analog initially chosen with the developed interpretation, and may when displayed include: compare the stratigraphic interpretation of the basin to that of the selected analog and iterate, compare the influence of the structural interpretation on depositional patterns in the basin to that of the selected analog and iterate, and compare the reservoir quality fairways in the basin to that of the selected analog and iterate.

FIG. 10B is a flow chart illustrating a method of using the user selectable tasks for the seal basin analysis workflow for evaluating the basin's top and fault seal data for identification of basin-scale seal risks. The seal basin analysis workflow pages may include, but are not limited to: identify and map regional seal candidates 120, evaluate continuity and character of seal intervals 122, estimate membrane seal quality and fracture potential 124, and estimate seal potential of critical faults along migration pathways 126.

The tasks to identify and map regional seal candidates 120 provide an approach for identifying regional seal candidates from log, seismic, and outcrop data and for making regional maps of candidate seals, and may when displayed, include: identify seal intervals and master seal candidates, map seal candidates in sequence stratigraphic framework, and check consistency of identified seal intervals using regional basin trends, analogs, and literature. The tasks to evaluate continuity and character of seal intervals 122, provides guidance for identifying processes that reduce the continuity of candidate seal intervals such as channel incision, faulting, and fades changes, and may when displayed include: identify risks to regional seal continuity such as incision, faulting, and faces changes, and use regional basin knowledge to supplement understanding of continuity risk. The tasks for estimate membrane seal quality and fracture potential 124, provides steps for estimating membrane seal quality and mechanical and hydraulic fracture risk in candidate top seal intervals, and may when displayed include: estimate membrane seal quality from column height and rock property data, compile known distributions of column heights in the basin and compare with analogues, estimate mechanical and hydraulic fracture potential and create seal quality maps. The tasks for estimate seal potential of critical faults along migration pathways 126, provides steps for estimating along-fault and cross-fault sealing potential of critical faults along migration pathways during critical time windows for input into basin models, and may when displayed include: identify critical faults and critical migration timing, determine timing of critical fault movement as a proxy for timing of potential fault-plane hydrocarbon migration, and integrate basin model with fault plane mapping.

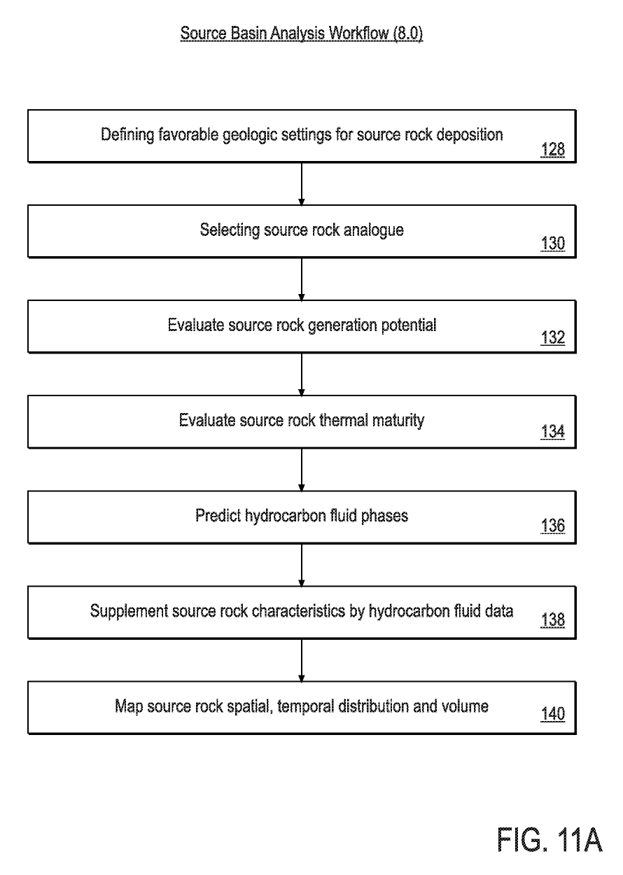

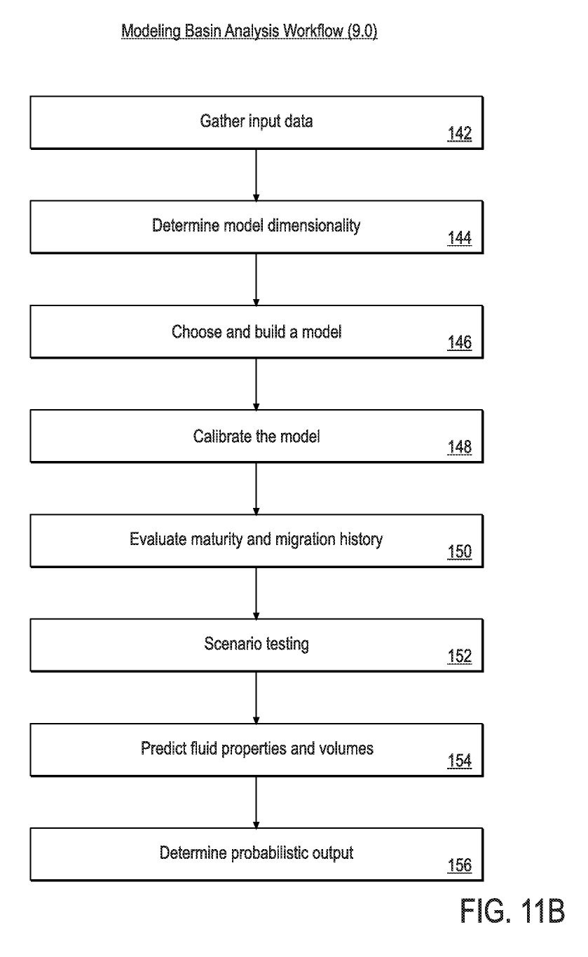

FIG. 11A is a flow chart illustrating a method of using the user selectable tasks for the source basin analysis workflow for analyzing and mapping the basin's source data. The source basin analysis workflow pages may include, but are not limited to: define favorable geologic settings for source rock deposition 128, select source rock analogue 130, evaluate source rock generation potential 132, evaluate source rock thermal maturity 134, predict hydrocarbon fluid phases 136, supplement source rock characteristics by hydrocarbon fluid data 138, and map source rock spatial, temporal distribution and volume 140.

The tasks for define favorable geologic settings for source rock deposition 128 identify the geographic locations and stratigraphic positions at which source rocks could have been accumulated in significant volume, and may when displayed include: define the basin type and subsidence history, and depict paleogeography. The tasks for select source rock analogue 130, selects geologically similar basins as analogue to evaluate source rock potential when no direct data are available from the basin of interest, and may when displayed include: tectonic and deposition settings, paleogeography and paleoclimate, geologic history, and source rock attributes. Tasks for evaluate source rock generation potential 132, may when displayed include: evaluate organic richness of rock samples, determine hydrocarbon generation potential of organic rich rocks, and identify likely source intervals on well logs. Tasks to evaluate source rock thermal maturity 134 assess the thermal evolution stage of source rock to determine if the source rock is mature enough to generate hydrocarbons or generated hydrocarbon in the past, and may when displayed include: estimate by rock depths, geothermal gradients and ages of the source rocks, determine source rock maturity by using geochemical analysis results, establish effective maturity by examining thermal maturity of hydrocarbon fluids, and compare maturity of hydrocarbon fluids with that of the reservoir rocks. Tasks to predict hydrocarbon fluid phases 136 provide information on the type of hydrocarbon fluids that can be expected, and may when displayed include: source rock kerogen type, source rock thermal maturity, potential alteration processes, hydrocarbon fluid shows, and hydrocarbon fluid phase in analogue basin.

Tasks for supplement source rock characteristics by hydrocarbon fluid data 138 verify the validity of speculated source rocks by comparing the source rock properties suggested by hydrocarbon fluids with the rock properties, and may when displayed include: alteration processes after hydrocarbon expulsion, source rock type suggested by hydrocarbon fluid, data, source rock depositional environment suggested by hydrocarbon fluid data, and source rock maturity level suggested by hydrocarbon fluid data. The tasks for map source rock spatial, temporal distribution and volume 140 present the source rock distribution in map view, including geographic distribution map, geologic distribution map and isopach map, and may when displayed include: map source rock area distribution, identify source rock in seismic stratigraphic framework, construct source rock isopach map, and construct source rock generation potential maps.

FIG. 11B is a flow chart illustrating a method, in one embodiment of the present invention of using the user selectable tasks for the modeling basin analysis workflow to calculate the timing of source rock maturity, and the subsequent expulsion, migration, and accumulation of hydrocarbons. Data from other basin analysis workflows can be integrated into a basin model to ensure quality basin analysis results. The modeling basin analysis workflow pages may include, but are not limited to: gather input data 142, determine model dimensionality 144, choose and build a model 146, calibrate the model 148, evaluate maturity and migration history 150, scenario testing 152, predict fluid properties and volumes 154, and determine probabilistic output 156.

The task for gather input data 142 may when displayed include integrating data from other basin analysis workflows when available, estimate by analog or software default data required to build a specific type of model in a basin where data has not been measured, and comparing the questions which need answering with the available data to help determine the appropriate model dimensionality. Tasks for determine model dimensionality 144, may when displayed include: ID requirements, 2D requirements, and 3D requirements. Tasks for choose and build a model 146 may when displayed include providing a ID example, 2D example, 2½D example, and 3D example. Task for calibrate the model 148 may when displayed include: calibrate to existing conditions, including: temperature, pressure, source rock maturity, hydrocarbon distribution, and porosity/permeability.

Tasks for evaluate maturity and migration history 150 may when displayed include: maturity of fetch area vs. time, migration efficiency, and petroleum systems diagram. A petroleum system diagram summarizes the timing of elements key to the success of a specific petroleum system into an easily readable format. Creation of a petroleum system diagram is a graphical means of defining the critical moment. Critical moment refers to the time that best depicts the generation-migration-accumulation of most hydrocarbons in a petroleum system. Tasks for scenario testing 152 may when displayed include: testing multiple input scenarios to quantify the risk associated with hydrocarbon charge assigned to any given prospect, and altering input variables to predict an appropriate range of outcomes. Tasks for predict fluid properties and volumes 154 may when displayed include: predicting the volume and phase of hydrocarbons and alteration/preservation. The tasks for determine probabilistic output 156 may when displayed include: apply variations (small range) to parameters used, in preferred scenario: temperature/depth of source rock, richness/thickness of source rock, migration efficiency, and variation in fetch area.

The basin analysis project results include a graphical output, wherein the graphical output includes the interactive technical activity planner and a graphical representation of the uncertainty related to the data used to perform the basin analysis.

Those skilled in the art will appreciate that the application of each basin analysis workflow will produce a variety of products or results, such as maps 1D, 2D, 2½D, 3D models, charts, graphs, interpretations, cross-sections, analyses and images, although not specifically listed.

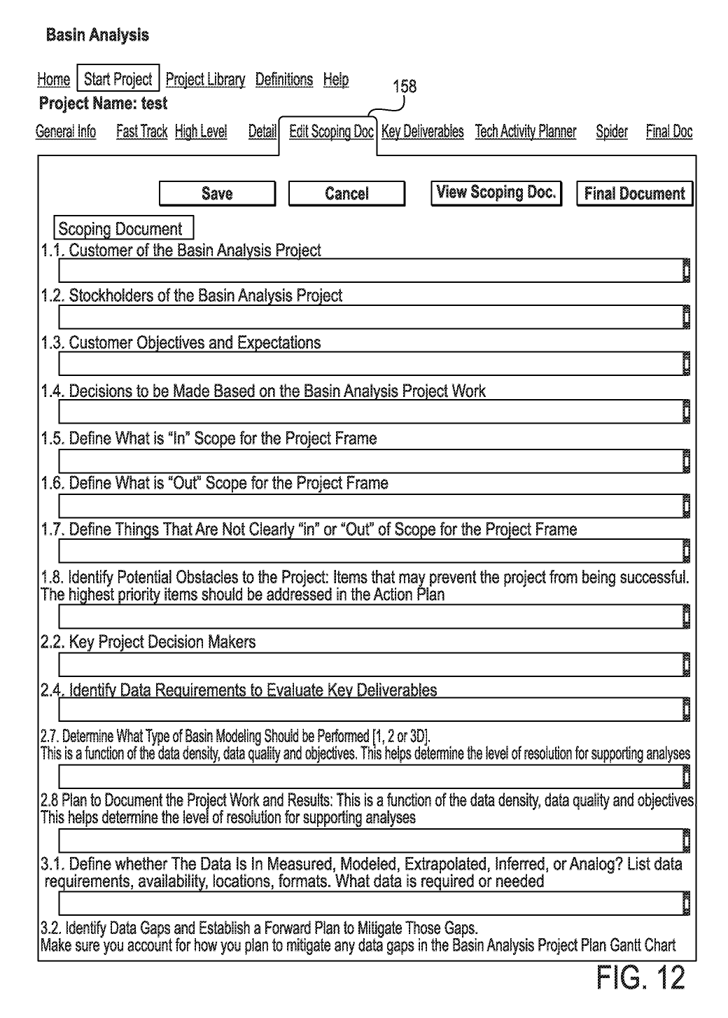

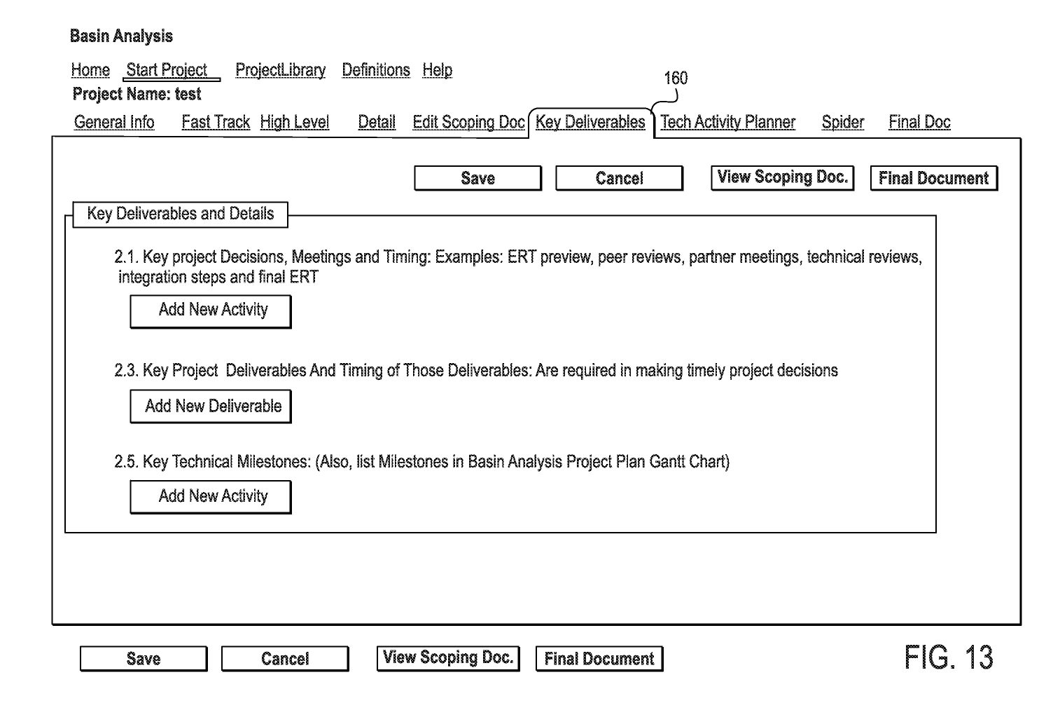

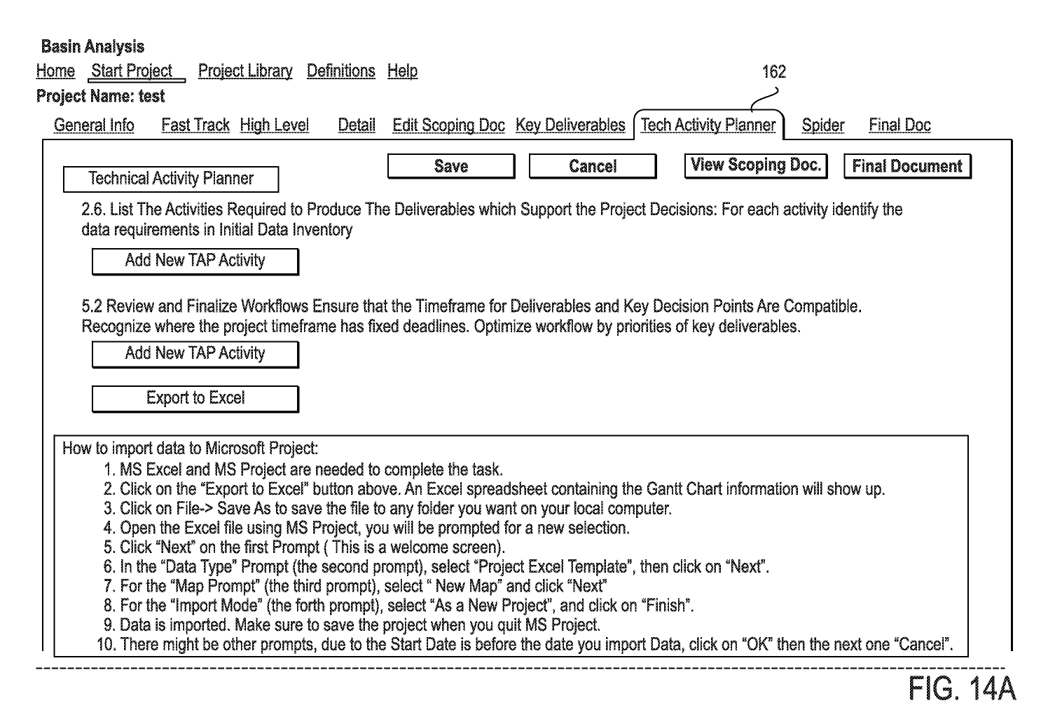

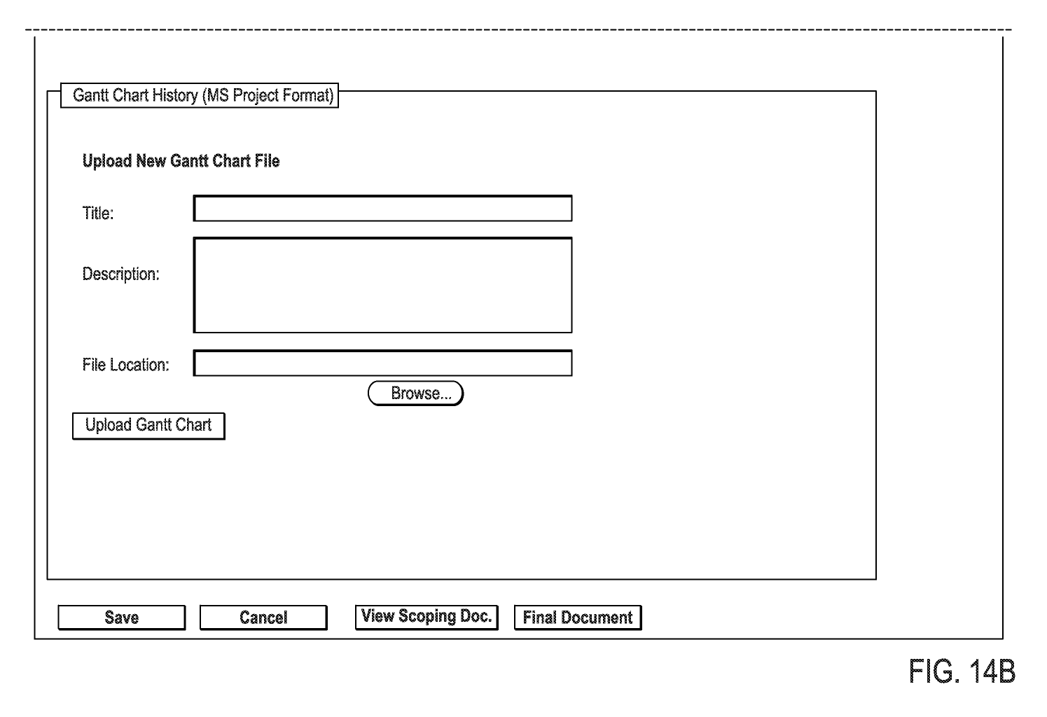

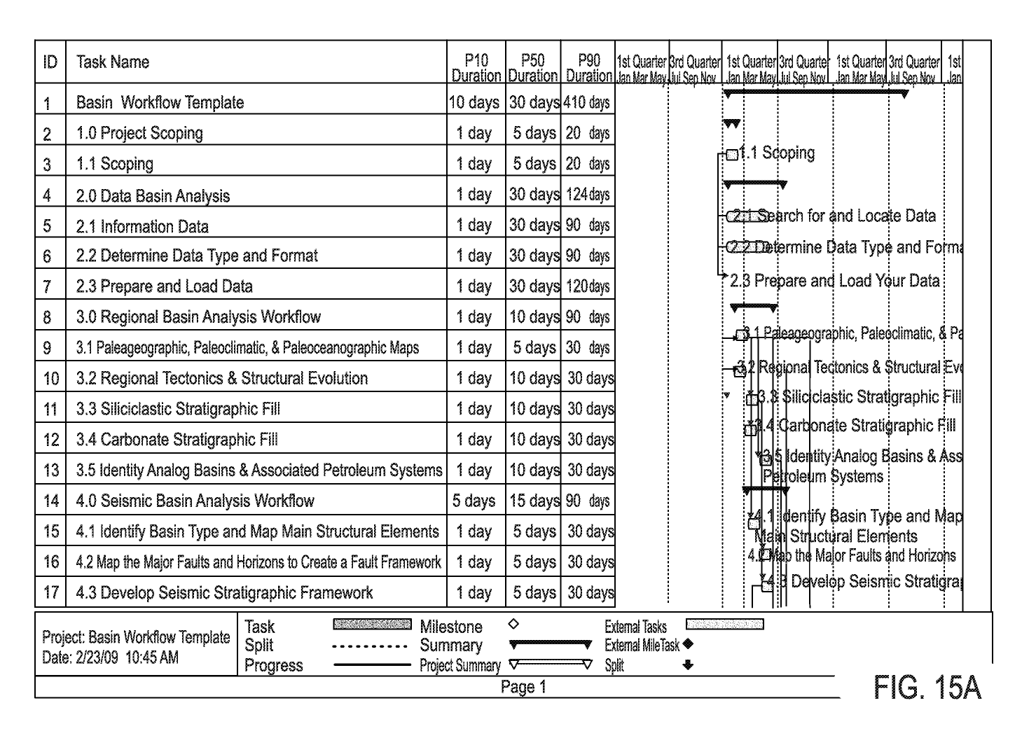

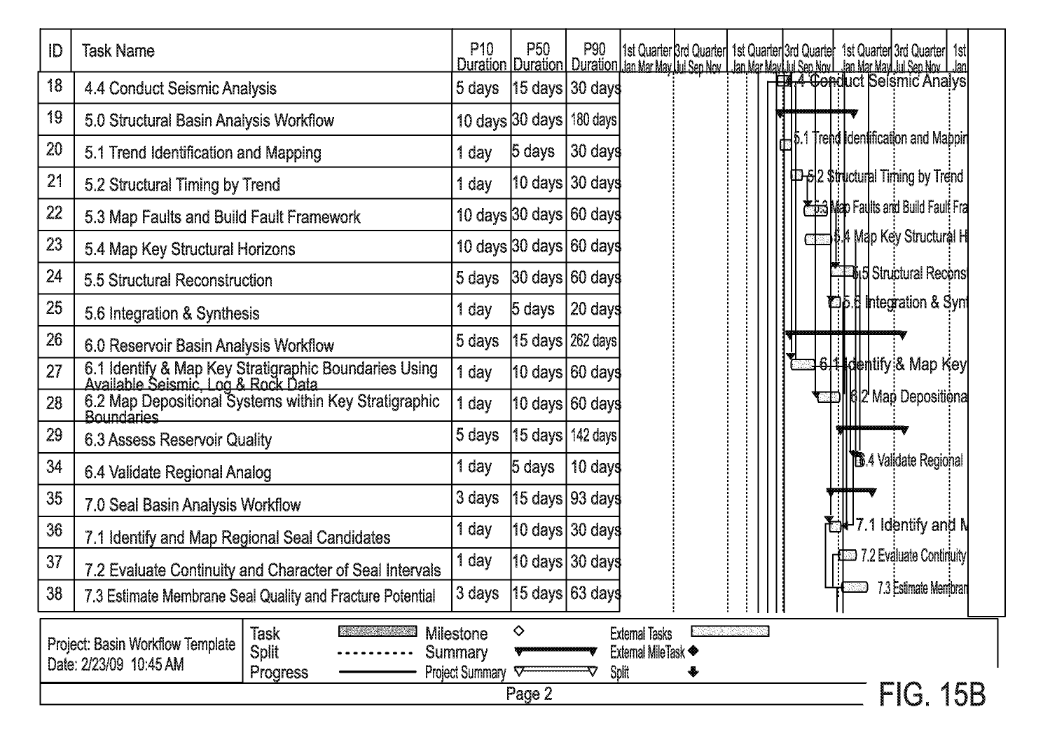

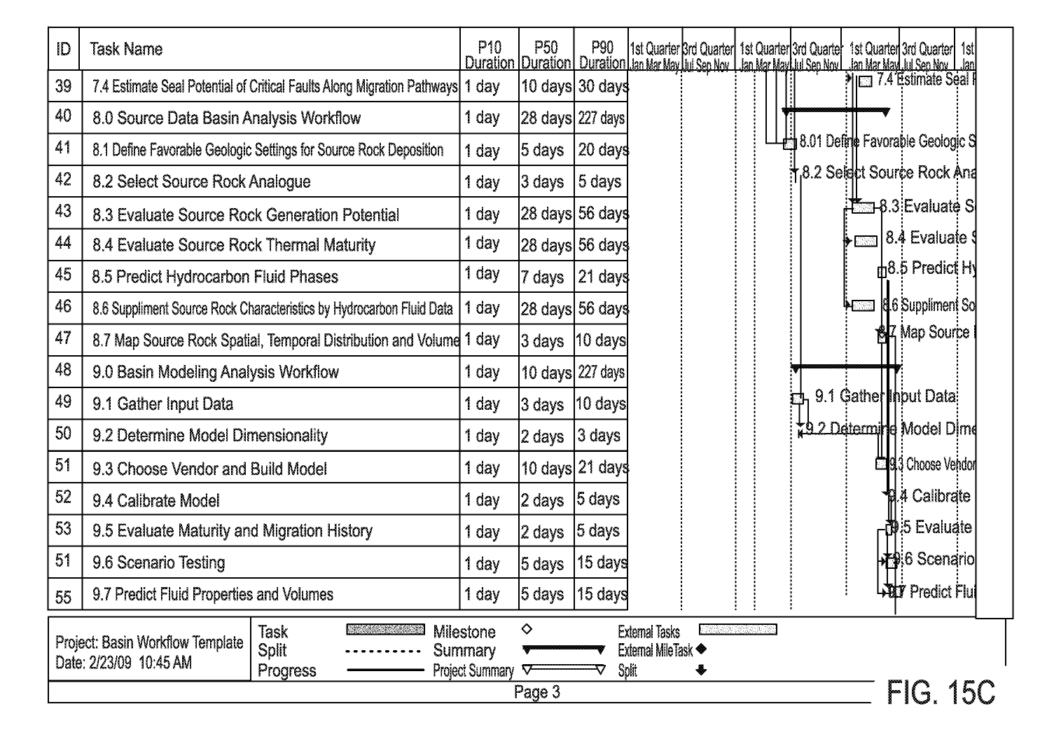

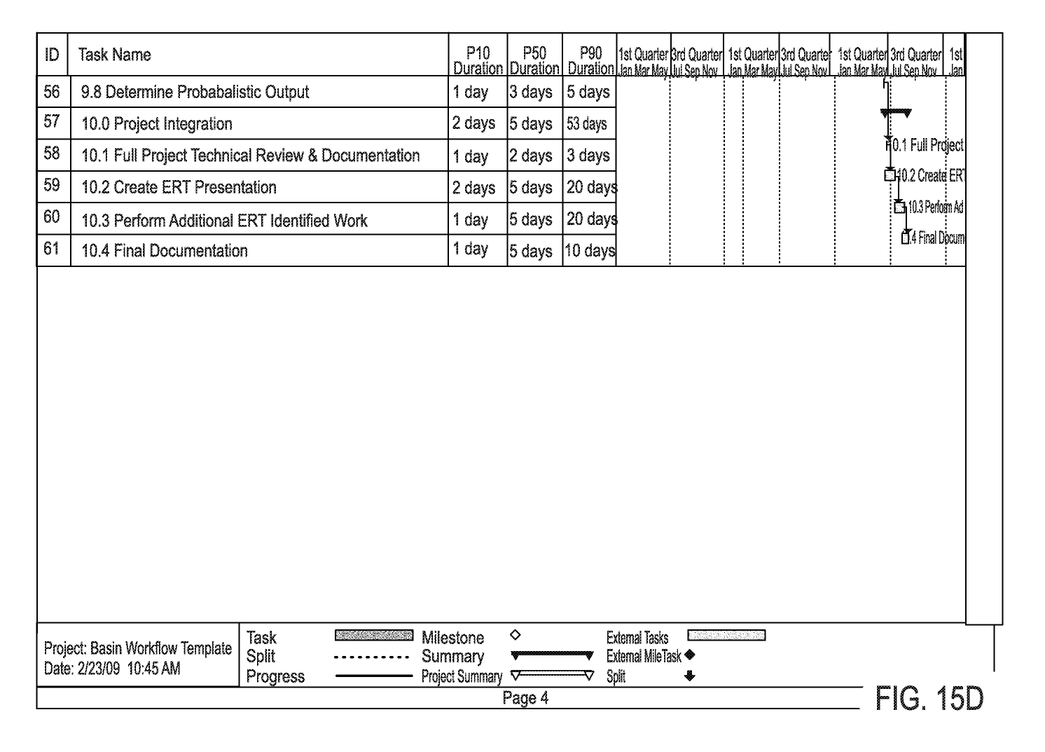

FIG. 12 illustrates an example of a web page of one embodiment of the present invention. The Edit Scoping Doc 158 can be accessed and tasks can be completed as the basin analysis project progresses. The information is supplemental to the Project Scoping data. Referring to FIG. 13, another example web page is shown. The Key Deliverables 160 page enables the user to complete tasks regarding the basin analysis project deliverables. The Key Deliverables may include activities that are required to produce the deliverables that support the basin analysis project decisions. FIGS. 14A and 14B illustrate example web pages for Tech Activity Planner 162. The information provided by the user in the previous operations, refer to FIG. 1 operations 14-18, using the web pages illustrated in FIGS. 3; 5, 6 or 7; 12; and 13, is used to generate a workflow planner or technical activity planner (“TAP”) for the basin analysis project, through the completion of the tasks set forth in FIGS. 14A and 14B by the user. The TAP is shown as a Gantt Chart, which is not intended to be limiting, showing the list of activities required to conduct the basin analysis and to produce the Key Deliverables 160. FIGS. 15A, 15B, 15C and 15D illustrate an example TAP planner in accordance with embodiments of the present invention. The TAP can be 5 uploaded to the integrated computer environment, exported to Excel, and modified as the project progresses. The TAP provides the basin analysis project team with a schedule for carrying out each operation of the basin analysis workflows. SharePoint, MS Project, PowerPoint and Excel are registered U.S. trademarks owned by Microsoft Corporation.

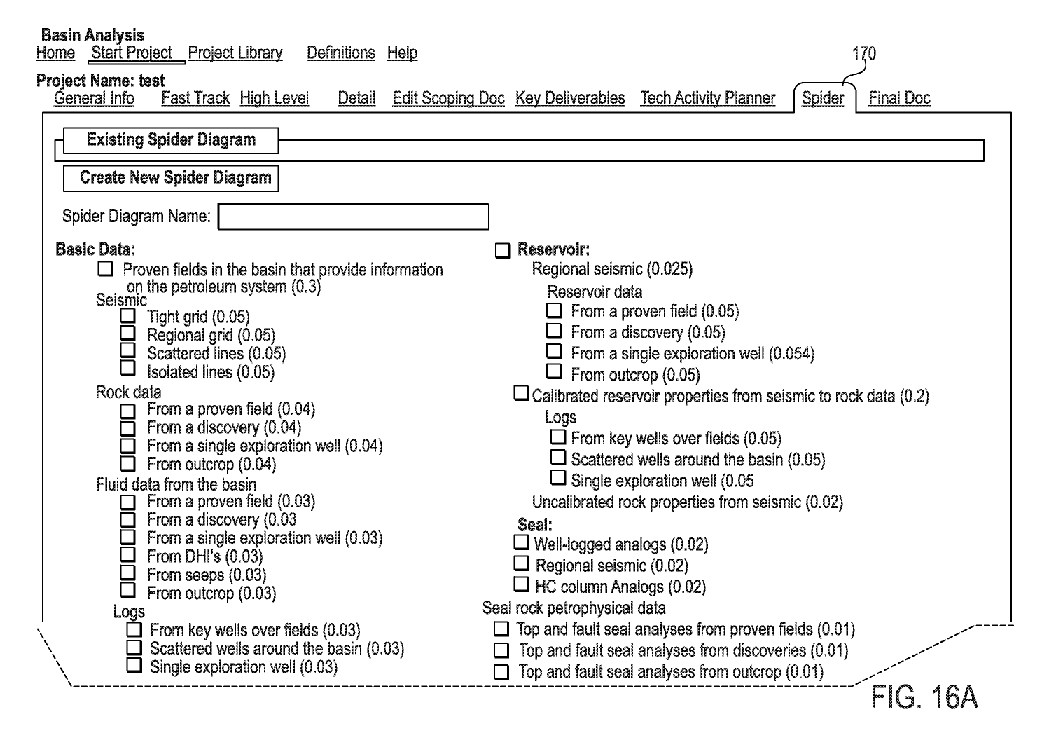

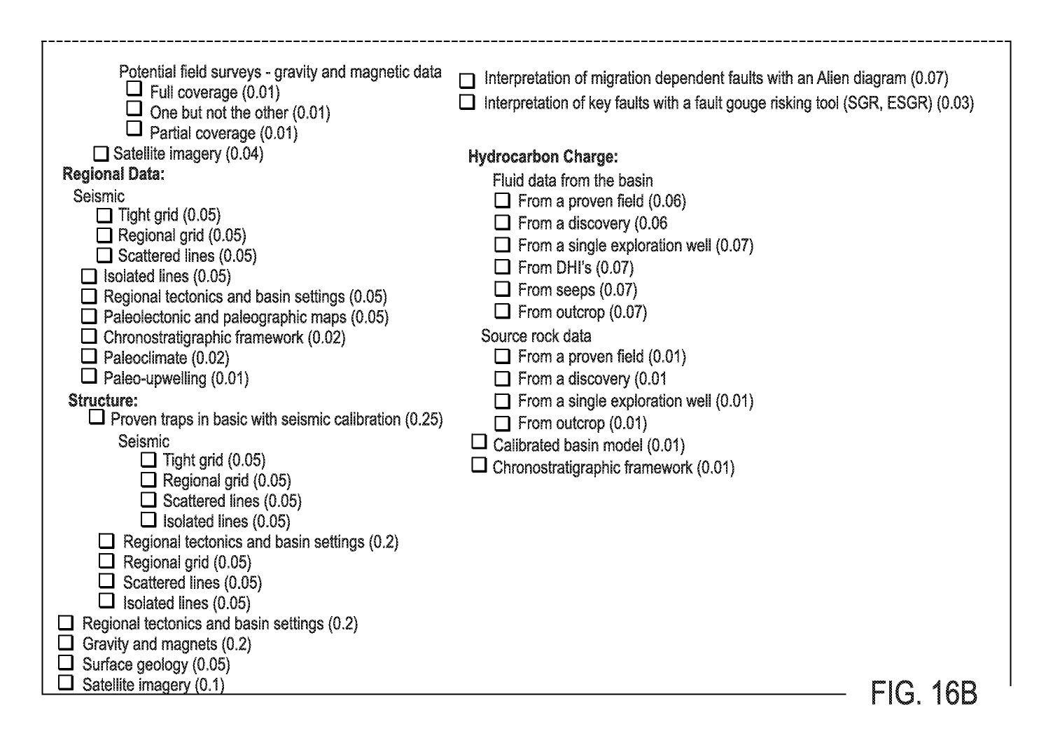

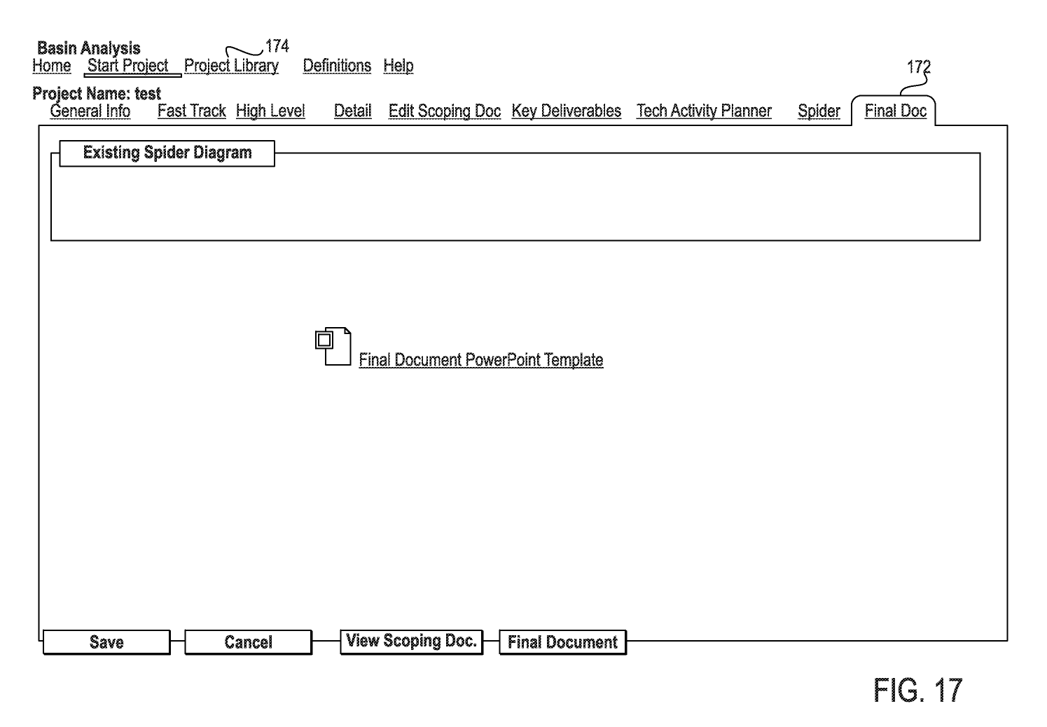

As the basin analysis project progresses and basin analysis workflows are completed in accordance with the TAP, the TAP and other web pages can be updated by a user. FIGS. 16A and 16B in one embodiment of the present invention, show a graphical output of the geological and geophysical data used, in the basin analysis workflows, such as a spider graph, to indicate areas lacking sufficient data scope or quality, and the level of confidence associated with each component analyzed. FIG. 17 shows the Final Doc 172, web pages, which compiles user selected basin analysis information into a presentable format, such as a PowerPoint presentation, to present to various exploration and asset teams as needed. A basin analysis project, which includes all the information related, to the basin, i.e. project scoping data, basin analysis workflow information, geological and geophysical data, etc. related, the basin, can be saved in the Project Library 174 at any time during the basin analysis project.

The user is guided through the multiple discipline technical analyses within each basin analysis workflow used, for conducting the basin analysis. The results of the basin analyses, project scoping data, and the geological and geophysical data are integrated in the integrated computer environment, to generate basin analysis project results for the basin, including the interactive technical activity planner. The project results optimize the implementation of basin analysis projects, promote consistency in conducting basin analysis, provide an efficient way of storing and accessing information regarding the entire petroleum system, prospect, basins and reservoirs, and to reduce the inhabitant risk in predicting the location of sedimentary rocks and structures that are likely to contain hydrocarbons in a subsurface area of interest.

It will be clear to one skilled in the art that the above embodiments may be altered in many ways without departing from the scope of the invention. While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

What is claimed is:

1. A computer implemented method for conducting geologic basin analysis in order to determine the accumulation of hydrocarbons in a subsurface region of interest, the method comprising:
(a) defining a basin analysis project relating to at least one basin within a subsurface region of interest using project scoping data and geological and geophysical data related to the subsurface region of interest in an integrated computer environment having at least a graphical user interface and multiple basin analysis workflows; each basin analysis workflow having user selectable tasks;
(b) applying at least one basin analysis workflow to the basin analysis project and performing user selected tasks in the integrated computer environment, to carry out a basin analysis including determining the basin characteristics, geological trends and the likelihood of a hydrocarbon system; wherein the use of the basin analysis workflow is based upon the volume of data provided by the user through the performance of the selected tasks and the basin analysis project scoping data; and
(c) integrating the results of the basin analysis, project scoping data, and the geological and geophysical data in the integrated computer environment, to generate basin analysis project results for the basin, including an interactive technical activity planner; wherein the project results are used to optimize and manage the performance of technical tasks required for the basin analysis project in order to determine the accumulation of hydrocarbons in the subsurface region of interest.

2. The method of claim 1 wherein the integrated computer environment comprises a user computer system, a network and a server; wherein the user computer system implements a web browser, and the user computer system displays web pages provided to the web browser by the server.

3. The method of claim 1 wherein the basin analysis project scoping data includes any one or more of defining project objectives, activities required to meet the project objectives, level of basin analysis required, experience level of the user, project start and end dates, exploration opportunity, subsurface data inventory and assessment, assessment of geological uncertainty, and prioritizing the project deliverables, costs, schedule, and budget.

4. The method, of claim 1 wherein the basin analysis project geological and geophysical data includes any one or more of the continent, country, latitude and longitude.

5. The method of claim 1, wherein the basin analysis project results include a graphical output, wherein the graphical output includes the interactive technical activity planner and a graphical representation of the uncertainty related to the data used to perform the basin analysis.

6. The method of claim 1, wherein each basin analysis project has access to, and is saved in, a searchable project library that can be used to link to data, including other active and inactive basin analysis projects.

7. The method of claim 1, wherein the basin analysis workflows include any one or more of data basin analysis workflow, regional basin analysis workflow, seismic basin analysis workflow, structural basin analysis workflow, reservoir basin analysis workflow, seal basin analysis workflow, source basin analysis workflow, and modeling basin analysis workflow.

8. The method of claim 7, wherein the data basin analysis workflow includes user selectable tasks for any one or more of search for and locate data, determine data type and format, and prepare and load data.

9. The method of claim 7, wherein the regional basin analysis workflow includes user selectable tasks for evaluating the regional context of the basin including any one or more of paleogeographic, paleoclimatic and paleoceanographic maps, regional tectonics and structural evolution, siliciclastic stratigraphic fill, carbonate stratigraphic fill, and identifying analog basins and associated petroleum systems.

10. The method of claim 7, wherein the seismic basin analysis workflow includes user selectable tasks for interpreting and mapping seismic data for the basin including any one or more of identify basin type and map main structural elements, map the major faults and horizons to create a fault framework, develop seismic stratigraphic framework and conduct seismic fades analysis.

11. The method of claim 7, wherein the structural basin analysis workflow includes user selectable tasks for analyzing the structure of the basin including any one or more of trend identification and mapping, structural timing by trend, map faults and building fault framework, map key structural horizons, structural reconstruction, and integration and synthesis.

12. The method of claim 7, wherein the reservoir basin analysis workflow includes user selectable tasks for analyzing the basin's reservoir and carrier bed systems including any one or more of identify and map key stratigraphic boundaries using available seismic, logging and rock data, map depositional systems within key stratigraphic boundaries, assess reservoir quality, and validate the regional analog.

13. The method of claim 7, wherein the seal basin analysis workflow includes user selectable tasks for evaluating the basin's top and fault seal data including any one or more of identify and map regional seal candidates, evaluate continuity and character of seal intervals, estimate membrane seal quality and fracture potential, and estimate seal potential of critical faults along migration pathways.

14. The method of claim 7, wherein the source basin analysis workflow includes user selectable tasks for analyzing and mapping the basin's source data including any one or more of define favorable geologic settings for source rock deposition, select source rock analogue, evaluate source rock generation potential, evaluate source rock thermal maturity, predict hydrocarbon fluid phases, supplement source rock characteristics by hydrocarbon fluid data, and map source rock spatial, temporal distribution and volume.

15. The method of claim 7, wherein the modeling basin analysis workflow includes user selectable tasks for basin modeling including any one or more of gather input data, determine model dimensionality, choose and build a model, calibrate the model, evaluate maturity and migration history, scenario testing, predict fluid properties and volumes, and determine probabilistic output.

16. A computer implemented method for conducting a geologic basin analysis to determine the accumulation of hydrocarbons in a subsurface region of interest, the method comprising:
(a) defining a basin analysis project relating to at least one basin within a subsurface region of interest using project scoping data and geological and geophysical data related to the subsurface region of interest in an integrated computer environment having at least a graphical user interface and multiple basin analysis workflows; each basin analysis workflow having user selectable tasks;
(b) applying an data basin analysis workflow, a regional basin analysis workflow, a seismic basin analysis workflow, a structural basin analysis workflow, a reservoir basin analysis workflow, a seal basin analysis workflow, a source basin analysis workflow, and a modeling basin analysis workflow, to the basin analysis project and performing end user selected tasks in the integrated computer environment, to carry out a basin analysis including determining the basin characteristics, geological trends and the likelihood of a hydrocarbon system; wherein the use of the basin analysis workflows are based, upon the volume of data provided by the user through the performance of the selected tasks and the basin analysis project scoping data; and
(c) integrating the results of the basin analyses, project scoping data, and the geological and geophysical data in the integrated computer environment, to generate basin analysis project results for the basin, including an interactive technical activity planner; wherein the project results are used to optimize and manage the performance of technical tasks required for the basin analysis project in order to determine the accumulation of hydrocarbons in the subsurface region of interest.

17. The method of claim 16, wherein the integrated computer environment comprises a user computer system, a network and a server; wherein the user computer system implements a web browser, and the user computer system displays web pages provided to the web browser by the server.

18. The method of claim 16, wherein the basin analysis project results include a graphical output, wherein the graphical output includes the interactive technical activity planner and a graphical representation of the uncertainty related to the data used to perform the basin analysis.

19. The method of claim 16, wherein each basin analysis project has access to, and is saved in, a searchable project library that can be used to link to data, including other active and inactive basin analysis projects.

20. A user computer system configured to perform a geologic basin analysis to determine the accumulation of hydrocarbons in a subsurface region of interest, the system comprising;
a data storage device having computer readable data including the project scoping data and the geological and geophysical data related to the subsurface region of interest, and a plurality of basin analysis workflows;
a graphical user interface;
a display device; and
a processor, configured and arranged to execute machine executable instructions stored in a processor accessible memory for performing a method comprising:
(a) defining a basin analysis project relating to at least one basin within a subsurface region of interest using project scoping data and geological and geophysical data related to the subsurface region of interest in an integrated computer environment having at least a graphical user interface and multiple basin analysis workflows; each basin analysis workflow having user selectable tasks;
(b) applying at least one basin analysis workflow to the basin analysis project and performing user selected tasks in the integrated computer environment, to carry out a basin analysis including determining the basin characteristics, geological trends and the likelihood of a hydrocarbon system; wherein the use of the basin analysis workflow is based upon the volume of data provided by the user through the performance of the selected tasks and the basin analysis project scoping data; and
(c) integrating the results of the basin analysis, project scoping data, and the geological and geophysical data in the integrated computer environment, to generate basin analysis project results for the basin, including an interactive technical activity planner; wherein the project results are used to optimize and manage the performance of technical tasks required for the basin analysis project in order to determine the accumulation of hydrocarbons in the subsurface region of interest.
